(19) United States
(12) Patent Application Publication
(10) Pub. No.: US 2024/0015529 A1
(43) Pub. Date: Jan. 11, 2024

(54) METHOD AND APPARATUS FOR USER PLANE PATH MANAGEMENT

(71) Applicant: Telefonaktiebolaget LM Ericsson (publ), Stockholm (SE)

(72) Inventor: Wenliang Xu, Shanghai (CN)

(21) Appl. No.: 18/021,288

(22) PCT Filed: Aug. 13, 2021
(86) PCT No.: PCT/CN2021/112522

§ 371 Date: Feb. 14, 2023

(30) Foreign Application Priority Data
Aug. 14, 2020 (WO) PCT/CN2020/109241

(51) Int. Cl. H04W 24/02; H04W 76/20

(52) U.S. Cl. CPC H04W 24/02; H04W 76/20

(57) ABSTRACT

Embodiments of the present disclosure provide method and apparatus for user plane path management. A method performed by an edge enabler server comprises receiving a first request from an edge application server. The first request comprises at least one identifier of at least one user equipment and an information element for indicating to the edge enabling server a request for delegation of user plane path management related to the at least one user equipment. The method further comprises sending a first response to the edge application server.

### TECHNICAL FIELD

The non-limiting and exemplary embodiments of the present disclosure generally relate to the technical field of communications, and specifically to methods and apparatuses for user plane path management.

### BACKGROUND

This section introduces aspects that may facilitate a better understanding of the disclosure. Accordingly, the statements of this section are to be read in this light and are not to be understood as admissions about what is in the prior art or what is not in the prior art.

Edge computing is a network architecture concept that enables cloud computing capabilities and service environments, which are deployed close to a user equipment (UE). It promises several benefits such as lower latency, higher bandwidth, reduced backhaul traffic and prospects for new services compared to the cloud environments. 3rd Generation Partnership Project (3GPP) TS 23.558 V0.4.0, the disclosure of which is incorporated by reference herein in its entirety, provides application layer architecture and related procedures for enabling edge applications over 3GPP networks.

3GPP TS 23.558 V0.4.0 specifies the application layer architecture, procedures and information flows necessary for enabling edge applications over 3GPP networks. It includes architectural requirements for enabling edge applications, application layer architecture fulfilling the architecture requirements and procedures to enable the deployment of edge applications.

FIG. 1 shows an example architecture for enabling edge applications. FIG. 1 is same as FIGS. 6.2-1 of 3GPP TS 23.558 V0.4.0. The Edge Data Network is a local Data Network. Edge Application Server(s) and the Edge Enabler Server are contained within the EDN. The Edge Configuration Server provides configurations related to the EES (edge enabler server), including details of the Edge Data Network hosting the EES. The UE contains Application Client(s) and the Edge Enabler Client. The Edge Application Server(s), the Edge Enabler Server and the Edge Configuration Server may interact with the 3GPP Core Network.

There may be some function entities in the edge computing. For example, one or more Application Clients (ACs) may be located in a UE. One or more Edge Enabler Clients (EECs) may be located in a UE. One or more Edge Configuration Servers (ECS(s)) may be deployed to support one edge data network. One ECS may be deployed to support one or more EDN(s). One or more ECS(s) may be deployed by a PLMN (Public Land Mobile Network) operator. One or more ECS(s) may be deployed by an Edge Computing Service Provider (ECSP). One or more Edge Enabler Servers (EES(s)) may be located in an EDN. One or more EES(s) may be located in an EDN per ECSP. One or more Edge Application Servers (EAS(s)) may be located in an EDN. EAS(s) belonging to the same EAS ID (identifier) can be provided by multiple ECSP(s) in an EDN.

EDGE-1 reference point may enable interactions between the Edge Enabler Server and the Edge Enabler Client. It may support:
a) registration and de-registration of the Edge Enabler Client to the Edge Enabler Server;
b) retrieval and provisioning of Edge Application Server configuration information; and
c) discovery of Edge Application Servers available in the Edge Data Network.

EDGE-3 reference point enables interactions between the Edge Enabler Server and the Edge Application Servers. It may support:
a) registration of Edge Application Servers with availability information (e.g. time constraints, location constraints);
b) de-registration of Edge Application Servers from the Edge Enabler Server; and
c) providing access to network capability information (e.g. location information).

EDGE-9 reference point may enable interactions between two Edge Enabler Servers. EDGE-9 reference point may be provided between EES within different EDN (FIG. 2) and within the same EDN (FIG. 3).

FIG. 2 shows an example of Inter-EDN EDGE-9. FIG. 3 shows an example of Intra-EDN EDGE-9.

EDGE-9 may supports:
a) discovery of target Edge Application Server information to support application context transfer.

The other reference points are described in clause 6.4 of 3GPP TS 23.558 V0.4.0.

There are some service capability APIs (application programming interfaces) exposed by the Edge Enabler Server to the Edge Application Server(s). The service capability APIs exposed include EES capabilities and exposed 3GPP Core Network capabilities. The 3GPP Core Network capabilities may be exposed from EES to the Edge Application Server(s)

Clause 8.6.3 of 3GPP TS 23.558 V0.4.0 describes User Plane Path Management events. As described in Clause 8.6.3 of 3GPP TS 23.558 V0.4.0, EES can expose its capabilities to EAS via EDGE-3 interface, the User Plane Path Management capability is one of them.

The Edge Enabler Server exposes user plane path management event notifications of an UE to an Edge Application Server (e.g. in order to trigger the application context relocation). User plane path management event notifications API exposed by the Edge Enabler Server may rely on Network Exposure Function (NEF) northbound API for monitoring event of user plane path management event.

The availability of the user plane path management event notifications may change due to various reasons such as UE mobility between 5GC (fifth generation core network) and EPC (Evolved Packet Core). If an Edge Enabler Server re-exposes the northbound API for user plane path management notifications of 3GPP Core Network to Edge Application Server(s) for a UE, the Edge Enabler Server monitors the availability of the northbound API for UE(s) served by the Edge Application Server (e.g. by utilizing Nnef_APISupportCapability as in 3GPP TS 23.502 V16.5.1, the disclosure of which is incorporated by reference herein in its entirety) and provides the availability information to the Edge Application Server. If CAPIF (Common API Framework for 3GPP northbound APIs) is supported, the EES determines if the user plane path management event API is available and able to be exposed to the Edge Application Server for a UE via the Availability of service APIs event notifications provided by the CAPIF core function as in 3GPP TS 23.222 V17.1.0, the disclosure of which is incorporated by reference herein in its entirety.

FIG. 4 illustrates a subscribe/unsubscribe operation between the Edge Application Server and the Edge Enabler Server for user plane path management event notifications. FIG. 4 is same as FIG. 8.6.3.2-1 of 3GPP TS 23.558 V0.4.0 and each step of FIG. 4 has been described in clause 8.6.3.2 of 3GPP TS 23.558 V0.4.0.

FIG. 5 illustrates the notify operation between the Edge Enabler Server and the Edge Application Server for continuous User plane path management event notifications. FIG. 5 is same as FIG. 8.6.3.2-2 of 3GPP TS 23.558 V0.4.0 and each step of FIG. 5 has been described in clause 8.6.3.2 of 3GPP TS 23.558 V0.4.0.

As shown in FIGS. 4-5, the EES can bridge the request from EAS to 3GPP core network and also proxy the subsequent notification from 3GPP core network to the EAS.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems in the user plane path management in edge computing. For example, since the existing User Plane Path Management API is designed to be used by the EAS assuming the EAS takes full responsibility of the user plane path management including receiving the user plane path change notification and provisioning its subsequent traffic routing influence. There is a missing use case which is not covered by an existing solution as shown in FIGS. 4-5. The EES can also take the responsibility of receiving the user plane path change notification without notifying EAS and provisioning the subsequent traffic routing influence.

To overcome or mitigate at least one above mentioned problems or other problems, an improved user plane path management in edge computing may be desirable.

In an embodiment, an edge application server such as EAS can send a delegation request indication for user plane path management to the edge application server. The edge application server can move its user plane path management responsibility to the edge application server for the traffic routing influence.

In a first aspect of the disclosure, there is provided a method performed by an edge enabler server. The method comprises receiving a first request from an edge application server. The first request comprises at least one identifier of at least one user equipment and an information element for indicating to the edge enabling server a request for delegation of user plane path management related to the at least one user equipment. The method further comprises sending a first response to the edge application server.

In an embodiment, the method may further comprise checking whether the edge application server is authorized for the delegation of user plane path management.

In an embodiment, the method may further comprise, when the edge application server is authorized for the delegation of user plane path management, performing the delegation of user plane path management.

In an embodiment, the method may further comprise, when the edge application server is not authorized for the delegation of user plane path management, rejecting the delegation of user plane path management.

In an embodiment, the method may further comprise checking if there exists a subscription with a core network for user plane path management event notifications corresponding to the at least one user equipment.

In an embodiment, the method may further comprise, when the subscription with the core network does not exist, subscribing with the core network for the user plane path management event notifications of the at least one user equipment; and

In an embodiment, the method may further comprise, when the subscription with the core network exists, using locally cached user plane path management event notification information of the at least one user equipment.

In an embodiment, the method may further comprise detecting the user plane path management event of the at least one user equipment.

In an embodiment, the method may further comprise skipping a notification of the user plane path management event of the at least one user equipment to the edge application server when the edge application server is authorized for the delegation of user plane path management.

In an embodiment, the method may further comprise discovering and selecting a target edge application server.

In an embodiment, the method may further comprise influencing the user plane path of the at least one user equipment.

In an embodiment, the method may further comprise sending information regarding the target edge application server to the edge application server and/or the at least one user equipment.

In an embodiment, the method may further comprise reconfiguring the user plane path of the at least one user equipment.

In an embodiment, the delegation of user plane path management may comprise a delegation of checking if there exists a subscription with a core network for user plane path management event notifications corresponding to the at least one user equipment.

In an embodiment, the delegation of user plane path management may comprise, when the subscription with the core network does not exist, a delegation of subscribing with the core network for the user plane path management event notifications of the at least one user equipment.

In an embodiment, the delegation of user plane path management may comprise, when the subscription with the core network exists, a delegation of using locally cached user plane path management event notification information of the at least one user equipment.

In an embodiment, the delegation of user plane path management may comprise a delegation of detecting the user plane path management event of the at least one user equipment.

In an embodiment, the delegation of user plane path management may comprise a delegation of skipping a notification of the user plane path management event of the at least one user equipment to the edge application server when the edge application server is authorized for the delegation of user plane path management.

In an embodiment, the delegation of user plane path management may comprise a delegation of discovering and selecting a target edge application server; and a delegation of influencing the user plane path of the at least one user equipment.

In an embodiment, the delegation of user plane path management may comprise a delegation of sending information regarding the target edge application server to the edge application server and/or the at least one user equipment.

In an embodiment, the delegation of influencing the user plane path of the at least one user equipment comprises a delegation of reconfiguring the user plane path of the at least one user equipment.

In an embodiment, the first request may be a user plane path management event application programming interface (API) subscribe request.

In an embodiment, the method may further comprise receiving a second request from the edge application server, wherein the second request comprises an indication for cancelling the delegation of user plane path management related to one or more user equipments. The method may further comprise sending a second response to the edge application server.

The method may further comprise checking whether the edge application server is authorized for cancelling the delegation of user plane path management related to one or more user equipments; when the edge application server is authorized for cancelling the delegation of user plane path management related to one or more user equipments, cancelling the delegation of user plane path management related to one or more user equipments; and when the edge application server is not authorized for the delegation of user plane path management related to one or more user equipments, rejecting the cancelling of the delegation of user plane path management related to one or more user equipments.

In an embodiment, the second request may be a user plane path management event application programming interface (API) unsubscribe request.

In a second aspect of the disclosure, there is provided a method performed by an edge application server. The method comprises sending a first request to an edge enabler server. The first request comprises at least one identifier of the at least one user equipment and an information element for indicating to the edge enabling server a request for delegation of user plane path management related to the at least one user equipment. The method further comprises receiving a first response from the edge enabler server.

In an embodiment, the method may further comprise sending a second request to the edge enabler server, wherein the second request comprises an indication for cancelling the delegation of user plane path management related to one or more user equipments.

In an embodiment, the method may further comprise receiving a second response from the edge enabler server.

In a third aspect of the disclosure, there is provided an edge enabler server. The edge enabler server comprises a processor and a memory coupled to the processor. Said memory contains instructions executable by said processor. Said edge enabler server is operative to receive a first request from an edge application server. The first request comprises at least one identifier of at least one user equipment and an information element for indicating to the edge enabling server a request for delegation of user plane path management related to the at least one user equipment. Said edge enabler server is further operative to send a first response to the edge application server.

In a fourth aspect of the disclosure, there is provided an edge application server. The edge application server comprises a processor and a memory coupled to the processor. Said memory contains instructions executable by said processor. Said edge application server is operative to send a first request to an edge enabler server. The first request comprises at least one identifier of the at least one user equipment and an information element for indicating to the edge enabling server a request for delegation of user plane path management related to the at least one user equipment. Said edge application server is further operative to receive a first response from the edge enabler server.

In a fifth aspect of the disclosure, there is provided an edge enabler server. The edge enabler server comprises a receiving module and a sending module. The receiving module may be configured to receive a first request from an edge application server. The first request comprises at least one identifier of at least one user equipment and an information element for indicating to the edge enabling server a request for delegation of user plane path management related to the at least one user equipment. The sending module may be configured to send a first response to the edge application server.

In a sixth aspect of the disclosure, there is provided an edge application server. The edge application server comprises a sending module and a receiving module. The sending module may be configured to send a first request to an edge enabler server. The first request comprises at least one identifier of the at least one user equipment and an information element for indicating to the edge enabling server a request for delegation of user plane path management related to the at least one user equipment. The receiving module may be configured to receive a first response from the edge enabler server.

In a seventh aspect of the disclosure, there is provided a computer program product comprising instructions which, when executed on at least one processor, cause the at least one processor to carry out any of the methods according to the first and second aspects of the disclosure.

In an eighth aspect of the disclosure, there is provided a computer-readable storage medium storing instructions which, when executed on at least one processor, cause the at least one processor to carry out any of the methods according to the first and second aspects of the disclosure.

Embodiments herein afford many advantages, of which a non-exhaustive list of examples follows. Some embodiments herein may provide a way for the edge enabler server to take full responsibility of the user plane path management including receiving the user plane path change notification and provisioning its subsequent traffic routing influence. Some embodiments herein may enable a delegation request indication to be sent from the edge application server to the edge enabler server so the edge application server moves its full or a part of responsibility to the edge application server for the traffic routing influence. Some embodiments herein may provide a possibility of edge enabler server decision (delegated) to influence the traffic routing, so edge enabler server can take different actions (e.g. to trigger the application context relocation). The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example architecture for enabling edge applications;

FIG. 2 shows an example of Inter-EDN EDGE-9;

FIG. 3 shows an example of Intra-EDN EDGE-9;

FIG. 4 illustrates a subscribe/unsubscribe operation between the Edge Application Server and the Edge Enabler Server for user plane path management event notifications;

FIG. 5 illustrates the notify operation between the Edge Enabler Server and the Edge Application Server for continuous User plane path management event notifications;

FIG. 6 schematically shows a high level architecture in a 4G network;

FIG. 7 schematically shows a high level architecture in a 5G network;

FIG. 8 shows a flowchart of a method according to an embodiment of the present disclosure;

FIG. 9 shows a flowchart of a method of discovering a target edge application server according to an embodiment of the present disclosure;

FIG. 10 shows a flowchart of a method according to another embodiment of the present disclosure;

FIG. 11 shows a flowchart of a method according to an embodiment of the present disclosure;

FIG. 12 shows a flowchart of a method according to an embodiment of the present disclosure;

FIG. 13 illustrates the subscribe/unsubscribe operation between the Edge Application Server and the Edge Enabler Server for user plane path management event notifications;

FIG. 14 illustrates the notify operation between the Edge Enabler Server and the Edge Application Server for continuous User plane path management event notifications;

FIG. 15 is a block diagram showing an apparatus suitable for practicing some embodiments of the disclosure;

FIG. 16 is a block diagram showing an edge enabler server according to an embodiment of the disclosure; and

FIG. 17 is a block diagram showing an edge application server according to an embodiment of the disclosure.

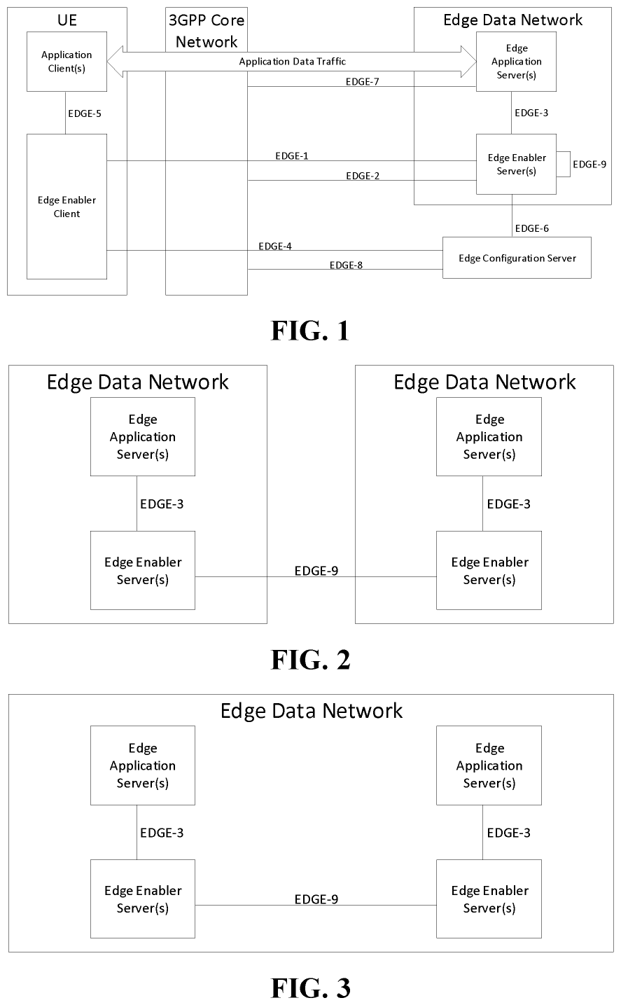

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable wireless communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols as may comprise the first generation (1G), 2G, 3G, 4G, 4.5G, 5G communication protocols, and/or any other protocols either currently known or to be developed in the future.

The term “network function” refers to any suitable function which can be implemented in a network entity (physical or virtual) of a communication network. For example, a network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), service capability exposure function (SCEF), etc. In other embodiments, the network function may comprise different types of NFs for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to the cellular network as defined by 3GPP being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies such as wireless sensor network may equally be utilized as long as exemplary embodiments described herein are applicable.

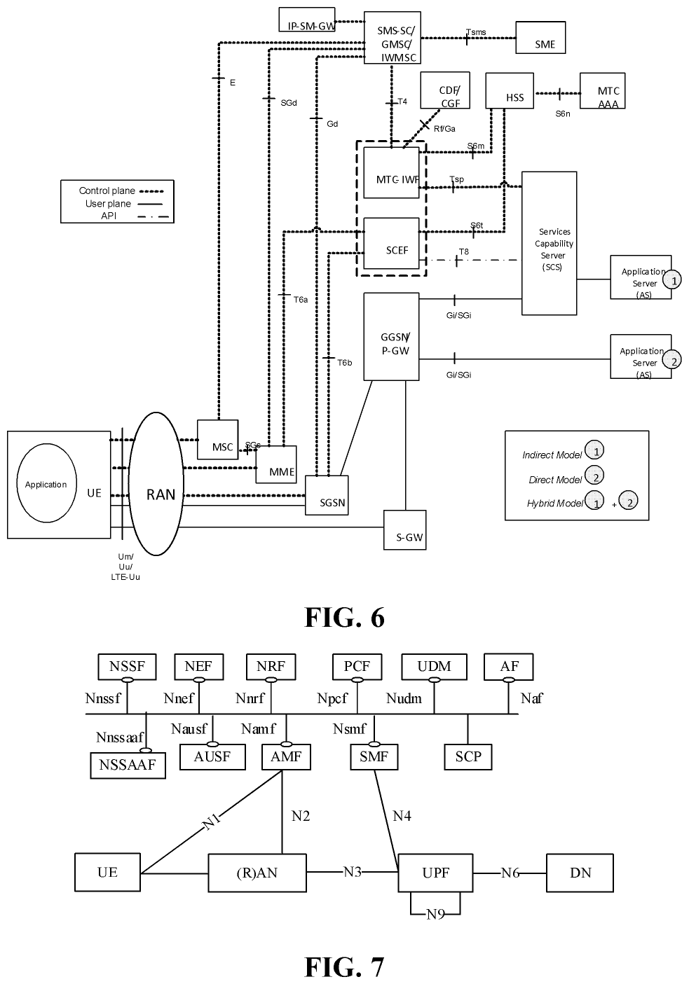

FIGS. 6-7 show some system architectures in which the embodiments of the present disclosure can be implemented. For simplicity, the system architectures of FIGS. 6-7 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

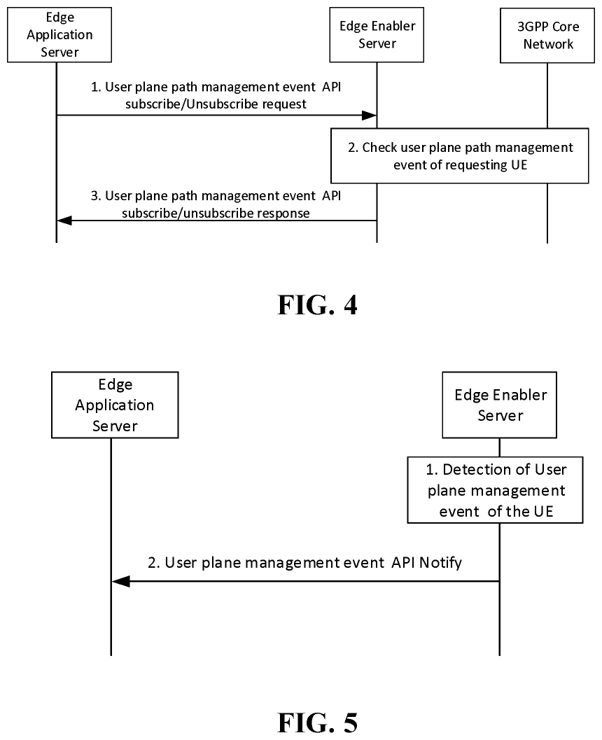

FIG. 6 schematically shows a high level architecture in a 4G network, which is same as FIG. 4.2-1a of 3GPP TS 23.682 V16.6.0, the disclosure of which is incorporated by reference herein in its entirety. The system architecture of FIG. 6 may comprise some exemplary elements such as SCS, AS, SCEF, HSS (home subscriber server), UE, RAN(Radio Access Network), SGSN (Serving GPRS(General Packet Radio Service) Support Node), MME (Mobile Management Entity), MSC(Mobile Switching Centre), S-GW(Serving Gateway), GGSN/P-GW(Gateway GPRS Support Node/PDN(Packet Data Network) Gateway), MTC-IWF(Machine Type Communications-InterWorking Function) CDF/CGF(Charging Data Function/Charging Gateway Function), MTC-AAA(Machine Type Communications-authentication, authorization and accounting), SMS-SC/GMSC/IWMSC(Short Message Service-Service Centre/Gateway MSC/InterWorking MSC) IP-SM-GW(Internet protocol Short Message Gateway). The network elements and interfaces as shown in FIG. 6 may be same as the corresponding network elements and interfaces as described in 3GPP TS 23.682 V16.6.0.

FIG. 7 schematically shows a high level architecture in a 5G network, which is same as FIG. 4.2.3-1 of 3GPP TS 23.501 V16.5.1, the disclosure of which is incorporated by reference herein in its entirety. The system architecture of FIG. 7 may comprise some exemplary elements such as AMF, SMF, AUSF, UDM, PCF, AF, NEF, UPF and NRF, (R)AN, SCP, NSSF, NSSAAF, etc. The network elements, reference points and interfaces as shown in FIG. 7 may be same as the corresponding network elements, reference points and interfaces as described in 3GPP TS 23.501 V16.5.1.

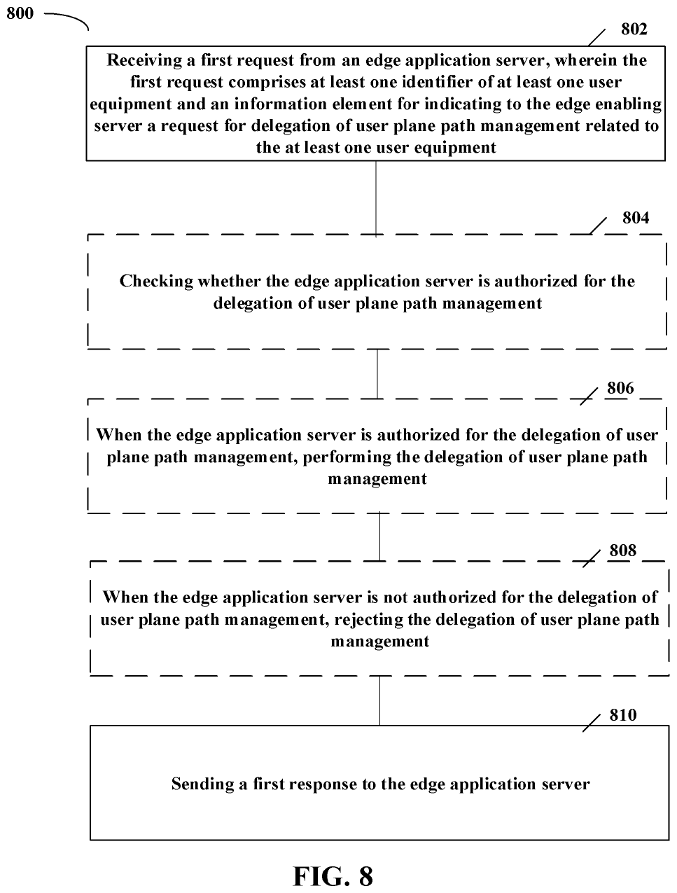

FIG. 8 shows a flowchart of a method according to an embodiment of the present disclosure, which may be performed by an apparatus implemented in or at or as an edge enabler server (such as EES) or communicatively coupled to the edge enabler server. As such, the apparatus may provide means or modules for accomplishing various parts of the method 800 as well as means or modules for accomplishing other processes in conjunction with other components.

At block 802, the edge enabler server may receive a first request from an edge application server. The first request may comprise at least one identifier of the at least one user equipment and an information element for indicating to the edge enabling server a request for delegation of user plane path management related to the at least one user equipment.

The edge application server may be an application server resident in the Edge Data Network, performing the server functions. The Application Client connects to the Edge Application Server in order to avail the services of the application with the benefits of Edge Computing. It is possible that the server functions of an application are available only as an Edge Application Server. However, it is also possible that certain server functions are available both at the edge and in the cloud, as an Edge Application Server and an Application Server resident in the cloud respectively. The server functions offered by an Edge Application Server and its cloud Application Server counterpart may be the same or may differ; if they differ, the Application Data Traffic exchanged with the Application Client may also be different. The Edge Application Server may consume the 3GPP Core Network capabilities in different ways, such as:
a) it may invoke 3GPP Core Network function APIs directly, if it is an entity trusted by the 3GPP Core Network;
b) it may invoke 3GPP Core Network capabilities through the Edge Enabler Server; and
c) it may invoke the 3GPP Core Network capability through the capability exposure functions i.e. SCEF or NEF.

In an embodiment, the edge application server may be EAS as described in 3GPP TS 23.558 V0.4.0.

The edge enabler server may provide supporting functions needed for Edge Application Servers and Edge Enabler Client. For example, functionalities of Edge Enabler Server may be:
a) provisioning of configuration information to Edge Enabler Client, enabling exchange of application data traffic with the Edge Application Server;
b) supporting the functionalities of API invoker and API exposing function as specified in 3GPP TS 23.222 V17.1.0;
c) interacting with 3GPP Core Network for accessing the capabilities of network functions either directly (e.g. via PCF) or indirectly (e.g. via SCEF/NEF/SCEF+NEF);
d) support the functionalities of application context transfer; and
e) supports external exposure of 3GPP network capabilities to the Edge Application Server(s) over EDGE-3.

In an embodiment, the edge enabler server may be EES as described in 3GPP TS 23.558 V0.4.0.

In an embodiment, the indication may be delegation request information element for indicating whether the EAS wants to delegate the user plane path management and subsequent traffic routing influence to the EES.

The first request may be any suitable request such as a modified existing request or a new request. In an embodiment, the first request may be a user plane path management event application programming interface (API) subscribe request as described in 3GPP TS 23.558 V0.4.0. The user plane path management event API subscribe request may further comprise the information element for indicating to the edge enabling server a request for delegation of user plane path management related to the at least one user equipment.

The edge enabler server may receive the first request from the edge application server due to various reasons. For example, the edge application server may send the first request to the edge enabler server due to overload on the edge application server or load balancing, etc.

The at least one identifier of the at least one user equipment may comprise one identifier or multiple identifiers or all identifiers of one or multiple or all UEs served by the edge application server.

At block 804, optionally, the edge enabler server may check whether the edge application server is authorized for the delegation of user plane path management. The edge enabler server may check whether the edge application server is authorized for the delegation of user plane path management in various ways. For example, the edge application server may need to acquire an access token for the edge enabler server from an authorization server and attaches the access token in the first request towards the edge enabler server. In this case, when the first request does not include the access token or includes an invalid access token for the edge enabler server, the edge application server is not authorized for the delegation of user plane path management, else the edge application server is authorized for the delegation of user plane path management.

At block 806, optionally, when the edge application server is authorized for the delegation of user plane path management, the edge enabler server may perform the delegation of user plane path management.

At block 808, optionally, when the edge application server is not authorized for the delegation of user plane path management, the edge enabler server may reject the delegation of user plane path management.

The delegation of user plane path management may comprise any suitable operations related to the user plane path management.

In an embodiment, the delegation of user plane path management may comprise a delegation of checking if there exists a subscription with a core network for user plane path management event notifications corresponding to the at least one user equipment. For example, the edge enabler server may check if there exists a subscription with the 3GPP core network for the user plane path management event notifications corresponding to the at least one user equipment information obtained in block 802 as described in 3GPP TS 23.501 V16.5.1 and 3GPP TS 23.502 V16.5.1, which may be triggered by other edge application server for the same UE. The edge enabler server checks the availability of the user plane path management event service for the UE

In an embodiment, when the subscription with the core network does not exist, the delegation of user plane path management may comprise a delegation of subscribing with the core network for the user plane path management event notifications of the at least one user equipment. For example, if a subscription with 3GPP core network does not exist, then the edge enabler server subscribes with the 3GPP core network (PCF, NEF or SCEF+NEF) for the user plane path management event notifications of the at least one user equipment as described in 3GPP TS 23.501 V16.5.1 and 3GPP TS 23.502 V16.5.1. If the edge application server provides Subscription Type and/or Indication of EES Acknowledgement, the Edge Enabler Server include the type of subscription the indication of “AF acknowledgement to be expected” as information on AF subscription to corresponding SMF events within the AF Request.

In an embodiment, when the subscription with the core network exists, the delegation of user plane path management may comprise a delegation of using locally cached user plane path management event notification information of the at least one user equipment. For example, if a subscription with 3GPP core network exists, then the edge enabler server may use the locally cached user plane path management event notification information of the at least one user equipment.

In an embodiment, the delegation of user plane path management may comprise a delegation of detecting the user plane path management event of the at least one user equipment. For example, the edge enabler server detects the user plane path management event of the at least one UE (e.g. receiving user plane path management event notification for the at least one UE from the 3GPP core network). If the target UE and the 3GPP network support mobility between 5GC and EPC, the edge enabler server may monitor the availability of the user plane path management event notification from the 3GPP network by utilizing Nnef_APISupportCapability or Availability of service APIs event notifications provided by the CAPIF core function as described in 3GPP TS 23.502 V16.5.1. In an embodiment, the edge enabler server may detect the user plane path management event of the at least one user equipment by using Notification of User Plane Management Events as described in clause 4.3.6.3 of 3GPP TS 23.502 V16.5.1.

In an embodiment, the delegation of user plane path management may comprise a delegation of skipping a notification of the user plane path management event of the at least one user equipment to the edge application server when the edge application server is authorized for the delegation of user plane path management.

In an embodiment, the delegation of user plane path management may comprise a delegation of discovering and selecting a target edge application server. This embodiment can support service continuity for application client in the UE to minimize service interruption while replacing the serving edge application server with a target edge application server. When a UE moves to a new location, different edge application servers may be more suitable for serving the application clients in the UE. Such transitions may not only result from a mobility event but also other non-mobility events. Generally, a source edge application server which is in communication with an application client is associated with an application context. to support service continuity, the application context from a source edge application server may be transferred to a target edge application server.

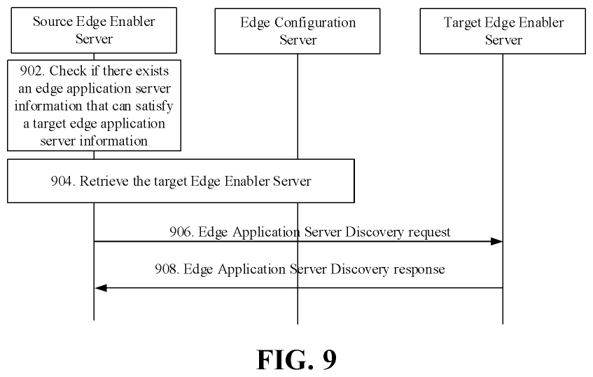

FIG. 9 shows a flowchart of a method of discovering and selecting a target edge application server according to an embodiment of the present disclosure. The source edge enabler server may discover the target edge application server due to various ways such as in response to a detected user plane path management event of a user equipment.

At block 902, the source edge enabler server checks if there exists an edge application server information (registered or cached) that can satisfy a target edge application server information (such as DNAI (DN (data network) Access Identifier) of the target edge application server) and additional filters (such as UE's location information, etc.). The DNAI of the target edge application server may be obtained via UP (user plane) path management event notification. The source edge enabler server may interact with 3GPP core network to retrieve the UE location. If the source edge enable server discovers and selects the target edge application server(s), the blocks 904, 906 and 908 are skipped, else at block 904 the source edge enabler server retrieves the target edge enabler server address from the edge configuration server as specified in clause 8.8.2.2 of 3GPP TS 23.558 V0.4.0.

At block 906, the source edge enabler server invokes the edge application server discovery request on the target edge enabler server.

At block 908, the target edge enabler server discovers the target edge application server(s) and responds with the discovered target edge application server information to the source edge enabler server. The source edge enabler server may cache the target edge application server information.

In an embodiment, the delegation of user plane path management may comprise a delegation of sending information regarding the target edge application server to the edge application server and/or the at least one user equipment.

In an embodiment, the delegation of user plane path management may comprise a delegation of influencing the user plane path of the at least one user equipment. For example, the influence on the user plane path of the at least one user equipment may be similar to application function influence on traffic routing as described in clause 5.6.7.2 of 3GPP TS 23.501 V16.5.1.

In an embodiment, the delegation of influencing the user plane path of the at least one user equipment comprises a delegation of reconfiguring the user plane path of the at least one user equipment. For example, the edge enabler server may send a request to 3GPP core network (such as NEF, SECF, NEF+SCEF, etc.) and another 3GPP core network node such as (SMF) may take appropriate actions to reconfigure the user plane path of the at least one user equipment.

With reference to FIG. 8, at block 810, the edge enabler server may send a first response to the edge application server. The first response may be any suitable response such as a modified existing response or a new response. In an embodiment, the first response may be User plane path management event API subscribe response as described in 3GPP TS 23.558 V0.4.0. for example, if the edge application server is authorized, the edge enabler server responds with a success response. If the edge application server is not authorized, the edge enabler server provides a rejection response with cause information.

In an embodiment, when the edge enabler server performs the delegation of user plane path management related to a user equipment, a corresponding delegation status may be set such as “yes” or “1” or changed such as from “no” to “yes” or from “0” to “1”. When the edge enabler server rejects the delegation of user plane path management related to a user equipment, a corresponding delegation status may be set such as “no” or “0” or changed such as from “yes” to “no” or from “1” to “0”.

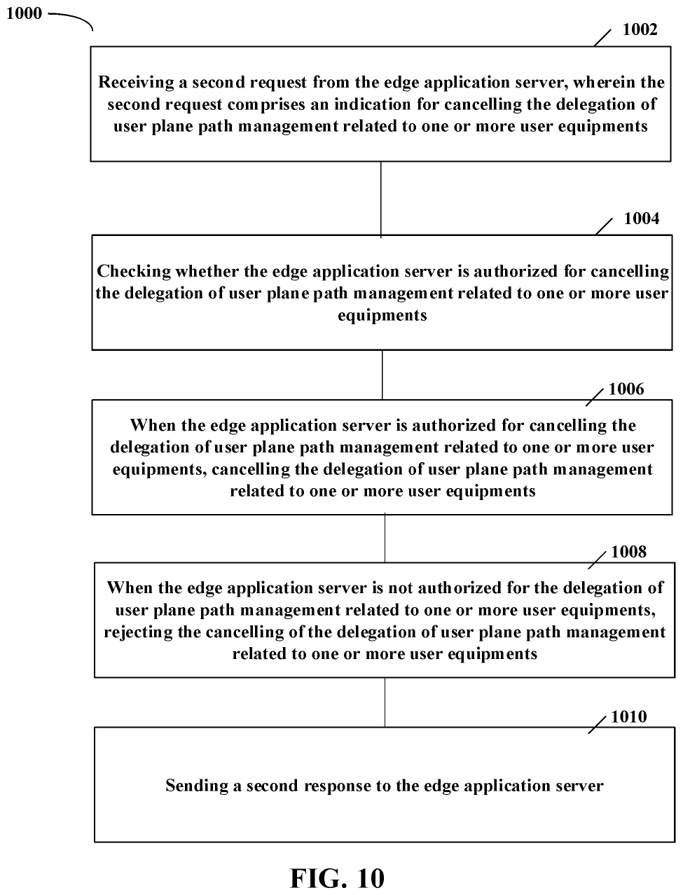

FIG. 10 shows a flowchart of a method according to another embodiment of the present disclosure. For some parts which have been described in the above embodiments, the description thereof is omitted here for brevity.

At block 1002, the edge enabler server may receive a second request from the edge application server, wherein the second request comprises an indication for cancelling the delegation of user plane path management related to one or more user equipments.

The second request may be any suitable request such as a modified existing request or a new request. In an embodiment, the second request may be a user plane path management event application programming interface (API) unsubscribe request as described in 3GPP TS 23.558 V0.4.0. The user plane path management event API unsubscribe request may further comprise the indication for cancelling the delegation of user plane path management.

The edge enabler server may receive the second request from the edge application server due to various reasons. For example, the edge application server may send the second request to the edge enabler server due to a change of the edge application server (e.g., the cancellation delegation operation may be a part of handling for a change of EAS and the old EAS may perform the cancellation delegation operation), load balancing, or the edge application server wants to take back the delegation (e.g. target EAS discovery and the traffic routing influence) from the edge enabler server, etc.

At block 1004, the edge enabler server may check whether the edge application server is authorized for cancelling the delegation of user plane path management related to one or more user equipments. The edge enabler server may check whether the edge application server is authorized for cancelling the delegation of user plane path management related to one or more user equipments in various ways. For example, the edge application server may need to acquire an access token for the edge enabler server from an authorization server and attaches the access token in the second request towards the edge enabler server. In this case, when the second request does not include the access token or includes an invalid token for the edge enabler server, the edge application server is not authorized for cancelling the delegation of user plane path management related to one or more user equipments, else the edge application server is authorized for cancelling the delegation of user plane path management related to one or more user equipments.

At block 1006, when the edge application server is authorized for cancelling the delegation of user plane path management related to one or more user equipments, the edge enabler server may cancel the delegation of user plane path management related to one or more user equipments.

At block 1008, when the edge application server is not authorized for the delegation of user plane path management related to one or more user equipments, the edge enabler server may reject the cancelling of the delegation of user plane path management related to one or more user equipments.

In an embodiment, when the edge enabler server cancels the delegation of user plane path management related to a user equipment, a corresponding delegation status may be set such as “no” or “0” or changed such as from “yes” to “no” or from “1” to “0”.

At block 1010, the edge enabler server may send a second response to the edge application server. The second response may be any suitable response such as a modified existing response or a new response. In an embodiment, the second response may be User plane path management event API unsubscribe response as described in 3GPP TS 23.558 V0.4.0. For example, if the edge application server is authorized, the edge enabler server responds with a success response. If the edge application server is not authorized, the edge enabler server provides a rejection response with cause information.

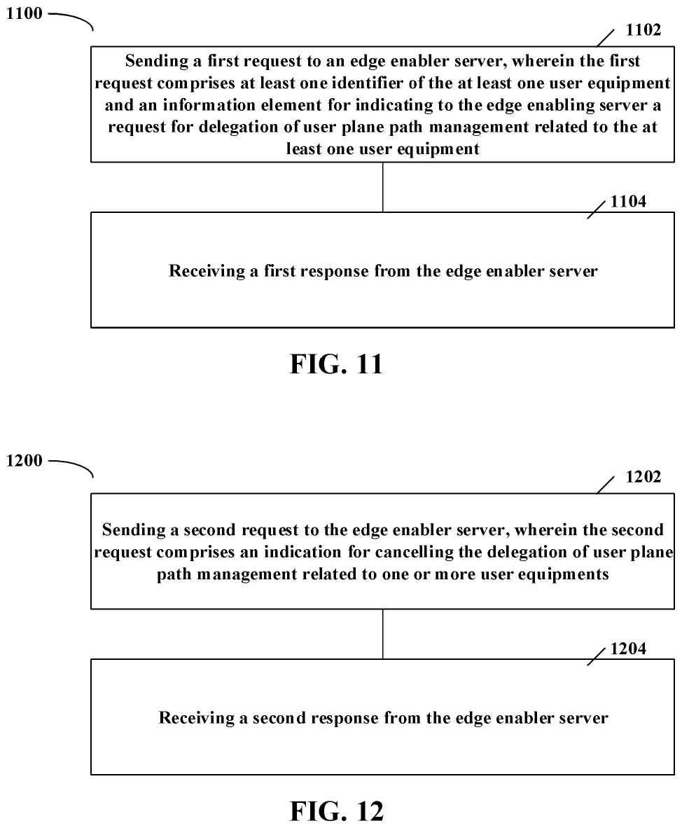

FIG. 11 shows a flowchart of a method according to an embodiment of the present disclosure, which may be performed by an apparatus implemented in or at or as an edge application server (such as EAS) or communicatively coupled to the edge application server. As such, the apparatus may provide means or modules for accomplishing various parts of the method 1100 as well as means or modules for accomplishing other processes in conjunction with other components.

At block 1102, the edge application server may send a first request to an edge enabler server. The first request may comprise at least one identifier of the at least one user equipment and an information element for indicating to the edge enabling server a request for delegation of user plane path management related to the at least one user equipment.

At block 1104, the edge application server may receive a first response from the edge enabler server.

FIG. 12 shows a flowchart of a method according to an embodiment of the present disclosure, which may be performed by an apparatus implemented in or at or as an edge application server (such as EAS) or communicatively coupled to the edge application server. As such, the apparatus may provide means or modules for accomplishing various parts of the method 1200 as well as means or modules for accomplishing other processes in conjunction with other components.

At block 1202, the edge application server may send a second request to the edge enabler server, wherein the second request comprises an indication for cancelling the delegation of user plane path management related to one or more user equipments

At block 1204, the edge application server may receive a second response from the edge enabler server.

In an embodiment, it introduces an enhancement to the existing UP path management API over EDGE-3 interface. In an embodiment, it can address the requirement for the EAS requested traffic routing influence delegation.

In an embodiment, a new API for delegating AF request to influence traffic routing may be necessary.

In an embodiment, the existing API in clause 8.6.3 of 3GPP TS 23.558 V0.4.0 can be enhanced to support the delegation of AF Request to influence traffic routing.

In an embodiment, it can enhance the existing API to support the delegation of AF Request to influence traffic routing. For example, the edge application server explicitly requests the edge enabler server to perform UP path management and the corresponding subsequent traffic routing influence.

In an embodiment, after delegation, the edge enabler server such as EES may take care of the traffic routing influence to a network such as the 3GPP Core Network upon reception of the User Plane path change notification from the network such as 3GPP Core Network.

In an embodiment, 3GPP TS 23.558 V0.4.0 may be amended as following:

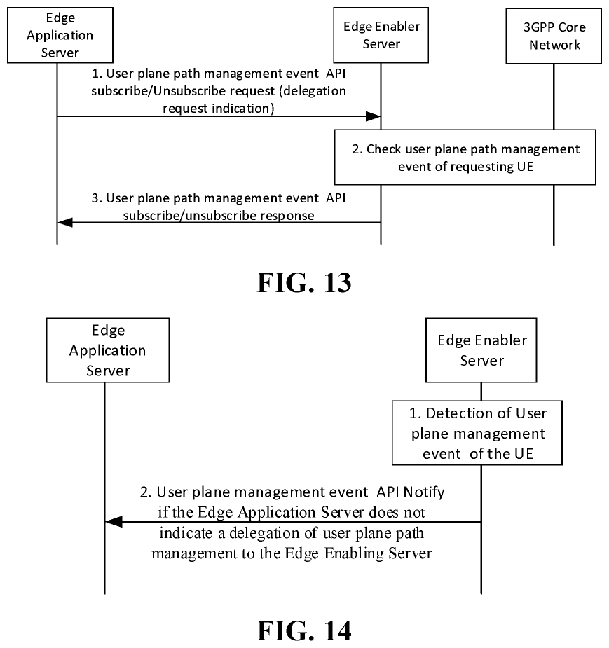

The various blocks/steps shown in FIGS. 8-14 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

Embodiments herein afford many advantages, of which a non-exhaustive list of examples follows. Some embodiments herein may provide a way for the edge enabler server to take full responsibility of the user plane path management including receiving the user plane path change notification and provisioning its subsequent traffic routing influence. Some embodiments herein may enable a delegation request indication to be sent from the edge application server to the edge enabler server so the edge application server moves its full or a part of responsibility to the edge application server for the traffic routing influence. Some embodiments herein may provide a possibility of edge enabler server decision (delegated) to influence the traffic routing, so edge enabler server can take different actions (e.g. to trigger the application context relocation). The embodiments herein are not limited to the features and advantages mentioned above. A person skilled in the art will recognize additional features and advantages upon reading the following detailed description.

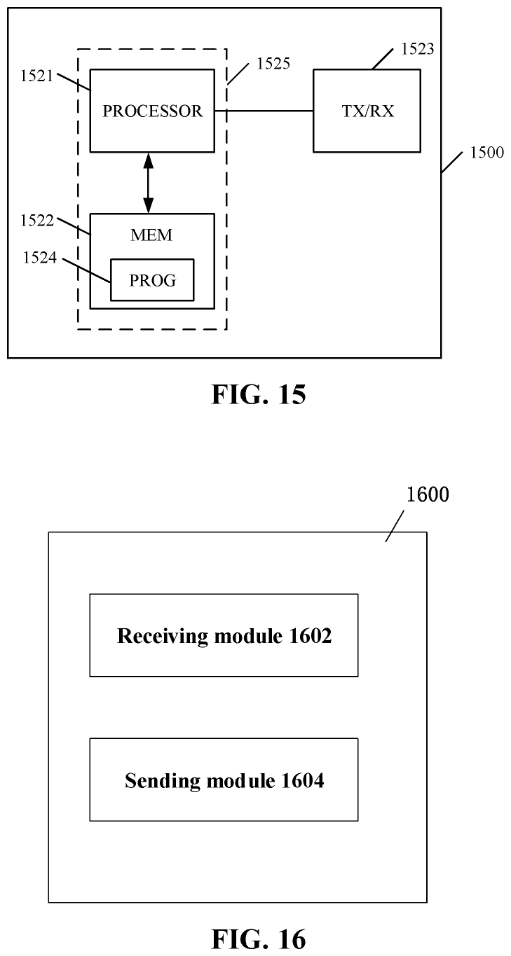

FIG. 15 is a block diagram showing an apparatus suitable for practicing some embodiments of the disclosure. For example, any one of the edge enabler server or the edge application server described above may be implemented as or through the apparatus 1500.

The apparatus 1500 comprises at least one processor 1521, such as a digital processor (DP), and at least one memory (MEM) 1522 coupled to the processor 1521. The apparatus 1520 may further comprise a transmitter TX and receiver RX 1523 coupled to the processor 1521. The MEM 1522 stores a program (PROG) 1524. The PROG 1524 may include instructions that, when executed on the associated processor 1521, enable the apparatus 1520 to operate in accordance with the embodiments of the present disclosure. A combination of the at least one processor 1521 and the at least one MEM 1522 may form processing means 1525 adapted to implement various embodiments of the present disclosure.

Various embodiments of the present disclosure may be implemented by computer program executable by one or more of the processor 1521, software, firmware, hardware or in a combination thereof.

The MEM 1522 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1521 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the edge enabler server, the memory 1522 contains instructions executable by the processor 1521, whereby the edge enabler server operates according to any step of any of the methods related to the edge enabler server as described above.

In an embodiment where the apparatus is implemented as or at the edge application server, the memory 1522 contains instructions executable by the processor 1521, whereby the edge application server operates according to any step of the methods related to the edge application server as described above.

FIG. 16 is a block diagram showing an edge enabler server according to an embodiment of the disclosure. As shown, the edge enabler server 1600 comprises a receiving module 1602 and a sending module 1604. The receiving module 1602 may be configured to receive a first request from an edge application server. The first request comprises at least one identifier of at least one user equipment and an information element for indicating to the edge enabling server a request for delegation of user plane path management related to the at least one user equipment. The sending module 1604 may be configured to send a first response to the edge application server.

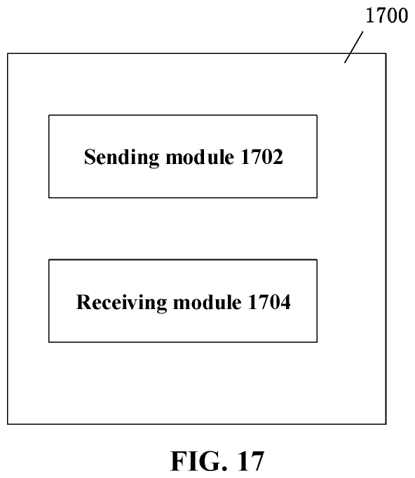

FIG. 17 is a block diagram showing an edge application server according to an embodiment of the disclosure. As shown, the edge application server 1700 comprises a sending module 1702 and a receiving module 1704. The sending module 1702 may be configured to send a first request to an edge enabler server. The first request comprises at least one identifier of the at least one user equipment and an information element for indicating to the edge enabling server a request for delegation of user plane path management related to the at least one user equipment. The receiving module 1704 may be configured to receive a first response from the edge enabler server.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the edge enabler server or the edge application server may not need a fixed processor or memory, any computing resource and storage resource may be arranged from the edge enabler server or the edge application server in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by an edge enabler server, comprising:
receiving a first request from an edge application server, wherein the first request comprises at least one identifier of at least one user equipment and an information element for indicating to the edge enabling server a request for delegation of user plane path management related to the at least one user equipment; and
sending a first response to the edge application server.

2. The method according to claim 1, further comprising:
checking whether the edge application server is authorized for the delegation of user plane path management;
when the edge application server is authorized for the delegation of user plane path management, performing the delegation of user plane path management; and
when the edge application server is not authorized for the delegation of user plane path management, rejecting the delegation of user plane path management.

3. The method according to claim 1, further comprising:
checking if there exists a subscription with a core network for user plane path management event notifications corresponding to the at least one user equipment;
when the subscription with the core network does not exist, subscribing with the core network for the user plane path management event notifications of the at least one user equipment; and
when the subscription with the core network exists, using locally cached user plane path management event notification information of the at least one user equipment.

4. The method according to claim 1, further comprising:
detecting the user plane path management event of the at least one user equipment.

5. The method according to claim 1, further comprising:
skipping a notification of the user plane path management event of the at least one user equipment to the edge application server when the edge application server is authorized for the delegation of user plane path management.

6. The method according to claim 1, further comprising:
discovering and selecting a target edge application server; and
influencing the user plane path of the at least one user equipment.

7. The method according to claim 1, further comprising:
sending information regarding the target edge application server to the edge application server and/or the at least one user equipment.

8. The method according to claim 1, further comprising: reconfiguring the user plane path of the at least one user equipment.

9. The method according to claim 1, wherein the first request is a user plane path management event application programming interface (API) subscribe request.

10. The method according to claim 1, further comprising:
receiving a second request from the edge application server, wherein the second request comprises an indication for cancelling the delegation of user plane path management related to one or more user equipments; and
sending a second response to the edge application server.

11. The method according to claim 10, further comprising:
checking whether the edge application server is authorized for cancelling the delegation of user plane path management related to one or more user equipments;
when the edge application server is authorized for cancelling the delegation of user plane path management related to one or more user equipments, cancelling the delegation of user plane path management related to one or more user equipments; and
when the edge application server is not authorized for the delegation of user plane path management related to one or more user equipments, rejecting the cancelling of the delegation of user plane path management related to one or more user equipments.

12. The method according to claim 10, wherein the second request is a user plane path management event application programming interface (API) unsubscribe request.

13. A method performed by an edge application server, comprising:
sending a first request to an edge enabler server, wherein the first request comprises at least one identifier of the at least one user equipment and an information element for indicating to the edge enabling server a request for delegation of user plane path management related to the at least one user equipment; and
receiving a first response from the edge enabler server.

14. The method according to claim 13, wherein the delegation of user plane path management comprises:
a delegation of checking if there exists a subscription with a core network for user plane path management event notifications corresponding to the at least one user equipment;
when the subscription with the core network does not exist, a delegation of subscribing with the core network for the user plane path management event notifications of the at least one user equipment; and
when the subscription with the core network exists, a delegation of using locally cached user plane path management event notification information of the at least one user equipment.

15. The method according to claim 14, wherein the delegation of user plane path management further comprises:
a delegation of detecting the user plane path management event of the at least one user equipment.

16. The method according to claim 15, the delegation of user plane path management further comprises:
a delegation of skipping a notification of the user plane path management event of the at least one user equipment to the edge application server when the edge application server is authorized for the delegation of user plane path management.

17. The method according to claim 13, wherein the delegation of user plane path management further comprises:
a delegation of discovering and selecting a target edge application server; and
a delegation of influencing the user plane path of the at least one user equipment.

18. The method according to claim 17, wherein the delegation of user plane path management further comprises:
a delegation of sending information regarding the target edge application server to the edge application server and/or the at least one user equipment.

19. The method according to claim 17, wherein the delegation of influencing the user plane path of the at least one user equipment comprises a delegation of reconfiguring the user plane path of the at least one user equipment.

20. (canceled)

21. The method according to claim 13, further comprising:
sending a second request to the edge enabler server, wherein the second request comprises an indication for cancelling the delegation of user plane path management related to one or more user equipments; and
receiving a second response from the edge enabler server.

22. (canceled)

23. An edge enabler server, comprising:
a processor; and
a memory coupled to the processor, said memory containing instructions executable by said processor, whereby said edge enabler server is operative to:
receive a first request from an edge application server, wherein the first request comprises at least one identifier of at least one user equipment and an information element for indicating to the edge enabling server a request for delegation of user plane path management related to the at least one user equipment; and
send a first response to the edge application server.

24. (canceled)

25. An edge application server, comprising:
a processor; and
a memory coupled to the processor, said memory containing instructions executable by said processor, whereby said edge application server is operative to:
send a first request to an edge enabler server, wherein the first request comprises at least one identifier of the at least one user equipment and an information element for indicating to the edge enabling server a request for delegation of user plane path management related to the at least one user equipment; and
receive a first response from the edge enabler server.

26-28. (canceled)
